(19) United States
(12) Patent Application Publication
(10) Pub. No.: US 2026/0290665 A1
(43) Pub. Date: Sep. 24, 2026

(54) IMPROVED TEMPERATURE-STABLE SOFT-MAGNETIC POWDER

(71) Applicant: BASF SE, Ludwigshafen am Rhein (DE)

(72) Inventors: Natalie DEHNHARDT-FEHST, Ludwigshafen am Rhein (DE); Rastko JOKSIMOVIC, Ludwigshafen am Rhein (DE); Daniel LOEFFLER, Ludwigshafen am Rhein (DE)

(21) Appl. No.: 19/490,130

(22) PCT Filed: May 29, 2024
(86) PCT No.: PCT/EP2024/064723

§ 371 Date: Dec. 4, 2025

(30) Foreign Application Priority Data
Jun. 5, 2023 (EP) 23177358.1

(51) Int. Cl. H01F 1/24; B22F 1/16; H01F 3/08; H01F 41/00; H01F 41/02

(52) U.S. Cl. CPC H01F 1/24; B22F 1/16; H01F 3/08; H01F 41/005; H01F 41/0246; B22F 2301/35; B22F 2304/10

(57) ABSTRACT

A soft magnetic powder coated with a silicon coating, wherein the silicon coating has a formula (I)

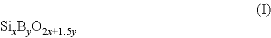

wherein, x=0.5-1.5
y=1.0-1.5, and
the soft magnetic powder coated with a silicon coating is obtained subsequent to a heat treatment at a temperature in the range from 350 to 700° C., and has a mean particle size D₅₀ between 0.5 and 250 μm.

The invention relates to a soft magnetic powder coated with a silicon coating and a process of coating the soft-magnetic powder. The invention further relates to the use of such soft-magnetic powder and an electronic component including such soft-magnetic powder.

### BACKGROUND OF THE INVENTION

A popular application of soft-magnetic powder includes magnetic core components, which serve as piece of magnetic material with a high permeability used to confine and guide magnetic fields in electrical, electromechanical and magnetic devices such as electromagnets, transformers, electric motors, inductors and magnetic assemblies. These components are usually produced in different shapes and sizes by molding soft-magnetic powder in a die under high pressure.

In electronic applications, particularly in alternating current (AC) applications, an important criterion to consider is the core loss characteristic. When a magnetic material is exposed to a rapidly varying field, the total energy of the core is reduced by the occurrence of hysteresis losses and/or eddy current losses. The hysteresis loss is caused by the necessary expenditure of energy to overcome the retained magnetic forces within the core component. The eddy current loss is caused by the production of electric currents in the core component due to the changing flux caused by AC conditions in the form of a resistive loss.

To reduce losses due to eddy currents, good insulation of the soft-magnetic powder particles is desired. The simplest way of achieving this is by coating the particles with a sufficiently thick insulating layer. However, the thicker the insulation layer is, the lower the core density of soft-magnetic particles gets and the magnetic flux density decreases, thereby adversely affecting the ability of the soft magnet to get magnetized. Thus, in order to manufacture a soft-magnetic powder core having optimal characteristics, it is necessary to increase the resistivity without adversely affecting the density of the core.

Another aspect of the insulation concerns temperature performance and durability of the insulation layer. Particularly high temperatures can result in degradation of the insulation layer by developing cracks which promote eddy current losses. Thus, temperature stability is a further requirement to manufacture a soft-magnetic powder core with optimal characteristics.

Another, often overlooked, aspect of the insulation concerns the corrosion stability of magnetic cores. Based on the working environment (exposure to corrosive chemicals and temperature), stability against corrosion is an important factor that determines the lifespan of the electronic component. Therefore, it is highly desirable if soft-magnetic powder particles could be covered with a thin insulating layer providing a high resistivity and a high density with a stable temperature and corrosion performance.

Known processes for forming insulating layers on magnetic particles typically target improved resistivity. US20210060642A1, for instance, reveals silicon oxide-coated soft magnetic powder having high compact density and excellent insulating property.

If the particles coated with the insulation layer are subject to temperatures over 150° C., preferably over 200° C., for a couple of hours the insulation layer can develop cracks, which lead to higher eddy currents and lower resistivity values. EP 2 871 646 A1 and EP3821450A1 address this problem by providing a soft-magnetic powder coated with a silicon-based coating which exhibits good properties with respect to temperature stability as well as resistivity. This is achieved by specific silicon-based coatings comprising fluorine in certain amounts. The temperature stability in EP3821450A1 is noted to be satisfactory at 180° C. for up to 24 hours, however, when the time period is increased, the stability is noted to reduce.

US 2008/0029300 A1 discloses an insulating magnetic metal particle that includes a magnetic metal particle containing at least one metal selected from the group consisting of Co, Fe, and Ni and having a diameter of 5 to 500 nm, a first inorganic insulating layer made of an oxide that covers the surface of the magnetic metal particle, and a second inorganic insulating layer made of an oxide that produces a eutectic crystal by reacting together with the first inorganic insulating layer at the time of heating them, the second inorganic insulating layer being coated on the first inorganic insulating layer. In a particular embodiment Fe particles having a particle size of 20 to 70 nm were immersed into a tetraethoxysilane solution to disperse them, thereby covering the surfaces of the Fe particles with a silicide, and the Fe particles were sintered at 400° C. after drying the particles to form a first inorganic insulating layer made of SiO₂ and having an average thickness of 4 nm.

Additionally, the presence of corrosive components in the coating layer (such as fluorine), can have adverse effect on the corrosion stability of the magnetic powder.

Therefore, in view of increasing demands to coated soft-magnetic powders, in particular with respect to heat and corrosion stability, there is still a need in the art to further improve the insulation layer of soft-magnetic powder in order to reach optimal results for magnetic core components prepared from such powders. Moreover, improvements in the process for coating the soft-magnetic powder are desirable.

Therefore, it is an object of the invention to provide an improved coated soft-magnetic powder and a corresponding process for coating a soft-magnetic powder that facilitates to achieve good temperature and corrosion stability, high resistivity and high permeability when utilized in magnetic core components. Furthermore, it is an object of the invention to provide a process which allows to achieve aforementioned goals in a simple, cost-effective and uncomplicated manner. Another object of the invention is to provide electronics components including soft-magnetic powder with good temperature stability, high resistivity, and high permeability.

### SUMMARY OF THE INVENTION

These objects are achieved by a soft magnetic powder coated with a silicon coating, wherein the silicon coating has a formula (I)

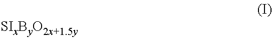

wherein, x=0.5-1.5
y=1.0-1.5, and
the soft magnetic powder coated with a silicon coating is obtained subsequent to a heat treatment at a temperature in the range from 350 to 700° C., and has a mean particle size D₅₀ between 0.5 and 250 μm.

The invention further relates to a process for obtaining the soft magnetic powder coated with a silicon coating as described herein, said process comprising the steps of:
a) mixing the soft-magnetic powder with a silicon precursor and at least one boron compound of formula II

BX₃ (II)
wherein X is selected from H, linear or branched C₁-C₆ alkyl, or linear or branched OC₁-C₆ alkyl, and
b) subjecting the mixture of step a) to heat treatment at a temperature in the range from 350 to 70° C. to obtain a soft magnetic powder coated with a silicon coating.

The invention also concerns the use of the coated soft-magnetic powder for manufacturing electronic components, in particular magnetic core components, as well as an electronic component, in particular a magnetic core component, including the coated soft-magnetic powder.

### DETAILED DESCRIPTION OF THE INVENTION

The following description concerns the coated soft-magnetic powder as well as the process for coating the soft-magnetic powder proposed by the invention. In particular, embodiments of the soft-magnetic powder, the boron compound and the silicon precursor applied to the soft-magnetic powder during the process for coating the soft-magnetic powder.

The invention provides a soft magnetic powder coated with a silicon coating and the process for obtaining said soft magnetic powder coated with a silicon coating which is optimally suitable for manufacturing electronic components. In particular, the soft magnetic powder coated with a silicon coating according to the invention allows to achieve high temperature durability, high corrosion resistance, high resistivity and high permeability when used for manufacture of electronic components, such as magnetic core components. Furthermore, owing to the simple and uncomplicated manner of the proposed method, a high batch-to-batch consistency can be achieved, which again allows for reliable production of electronic components. Additionally, the soft magnetic powders deliver high performance while avoiding involvement of environmentally hazardous components such as fluorine precursors. Overall, the soft magnetic powder coated with a silicon coating according to the invention facilitates to prepare electronic components with unique electromagnetic performance characteristics, high temperature durability, particularly for temperatures >150° C. and preferred >180° C. such as >200° C., and high corrosion resistance.

In the context of the present invention, boron (B) may be evenly distributed throughout the silicon coating, in other words forming a homogenous coating. Alternatively, the silicon coating may be inhomogeneous. In such a case the boron may be concentrated in a certain region of the coating. For example, the silicon coating may contain two or more layers of silicon dioxide (SiO₂), wherein one or more layers further contain boron component. The boron component as specified herein (obtainable from the boron compound) indicates a mean composition of the layered or inhomogeneous silicon coating.

In the context of the present invention, the silicon coating of the formula (I) may be considered a borosilicate glass.

In the context of the present invention specifications in % by weight (wt.-%) refer to the fraction of the total weight of soft-magnetic powder unless otherwise specified. Hence indications in wt.-% are based on the total dry weight of soft-magnetic powder excluding other components e.g. from the solution.

The soft-magnetic powder of the present invention comprises a plurality of particles with a mean particle size between 0.5 and 250 μm, preferably between 2 and 150 μm, more preferably between 2 and 10 μm. The mean particle size is the D₅₀ value of the particle size distribution of the particles. Preferably the mean particle size is 1 to 200 μm, more preferably 1 to 100 μm, even more preferably 1 to 50 μm, most preferably 2 to 20 μm. These particles may vary in shape. In respect of the shape, numerous variants known to the person skilled in the art are possible. Preferably, the shape of the powder particles is selected from needle-shaped, cylindrical, plate-shaped, teardrop-shaped, flattened or spherical. Soft-magnetic particles with various particle shapes are commercially available. Most preferred is a spherical shape as such particles can be coated more easily, which in fact results in a more effective insulation against electrical current. Preferably the particle size distribution is mono-modal.

Preferably, the soft-magnetic material comprises an elemental metal, an alloy or a mixture of one or more elemental metal(s) with one or more alloy(s). Typical elemental metals comprise Fe, Co, and Ni. Alloys may include Fe-based alloys, such as Fe—Si alloy, Fe—Si—Cr alloy, Fe—Si—Ni—Cr alloy, Fe—Al alloy, Fe—N alloy, Fe—Ni alloy, Fe—C alloy, Fe—B alloy, Fe—Co alloy, Fe—P alloy, Fe—Ni—Co alloy, Fe—Cr alloy, Fe—Mn alloy, Fe—Al—Si alloy, and ferrites, or rare earth based alloy, particularly rare earth Fe-based alloy, such as Nd—Fe—B alloy, Sn—Fe—N alloy or Sm—Co—Fe—Cu—Zr alloy, or Sr-ferrite, or Sm—Co alloy. More preferably, Fe or Fe-based alloys, such as Fe—Si—Cr, Fe—Si or Fe—Al—Si, serve as soft-magnetic material.

Even more preferably, Fe serves as soft-magnetic material and the soft-magnetic powder is a carbonyl iron powder (also referred to as CIP herein). Carbonyl iron can be obtained according to known processes by thermal decomposition of iron pentacarbonyl in a gas phase, as described, for example, in Ullmann's Encyclopedia of Industrial Chemistry, 5th Edition, Vol. A 14, page 599 or in DE 3 428 121 or in DE 3 940 347, and contains particularly pure metallic iron.

Carbonyl iron powder is a gray, finely divided powder of metallic iron having a low content of secondary constituents and consisting essentially of spherical particles having a mean particle diameter of up to 10 μm.

Unreduced carbonyl iron powder, which is preferred in the present context, has an iron content of >97% by weight (here based on the total weight of the powder), a carbon content of <1.5% by weight, a nitrogen content of <1.5% by weight and an oxygen content of <1.5% by weight. Reduced carbonyl iron powder, which is particularly preferred in the process of the present invention, has an iron content of >99.5% by weight (here based on the total weight of the powder), a carbon content of <0.1% by weight, a nitrogen content of <0.01% by weight and an oxygen content of <0.5% by weight. The mean diameter of the powder particles is preferably from 1 to 10 μm and their specific surface area (BET of the powder particles) is preferably from 0.1 to 2.5 m²/g.

One aspect of the invention pertains to soft magnetic powder, wherein the silicon coating has a formula (I):

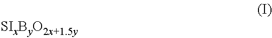

wherein x=0.5-1.5
y=1.0-1.5, and
the soft magnetic powder coated with a silicon coating is obtained subsequent to a heat treatment at a temperature in the range from 350 to 700° C., and has a mean particle size D₅₀ between 0.5 and 250 μm.

Preferably, in the composition of formula (I) x is a number in the range from 0.5 to 1.4, more preferably in the range from 0.6 to 1.2, even more preferably in the range from 0.7 to 1.0.

Preferably, in the composition of formula (I) y is a number in the range from 1.0 to 1.45, more preferably in the range from 1.05 to 1.45 and particularly preferably from 1.1 to 1.4.

Other than the silicon coatings specified above the coating could also be based on metal oxides such as aluminium oxide (Al₂O₃), magnesium oxide (MgO) or titanium oxide (TiO₂, TiO, Ti₂O₃). Such coatings can be produced by decomposition of metal alkoxides. Metal alkoxides are typically given by the formula M²(OR′)(OR″) . . . (ORⁿ), wherein M² is a metal and n the metal's valence. R′, R″, Rn specify organic residues, which can be the same or different. Preferably, R is selected from a linear or branch alkyl or a substituted or unsubstituted aryl. More preferably, R is selected from a C₁-C₈ alkyl, such as methyl, ethyl, n-propyl, iso-propyl, n-butyl, iso-butyl, sec.-butyl or tert.-butyl, n-hexyl, 2-ethylhexyl, or a C₆-C₁₂ aryl, such as phenyl, 2-, 3- or 4-methylphenyl, 2,4,6-trimethylphenyl or naphthyl. Even more preferred are methyl, ethyl and iso-propyl. Further details regarding the process of coating the soft-magnetic powder with the metal oxide, particularly SiO₂, are described below.

Preferably, the boron component of the coating can be embedded within a SiO₂ matrix and/or bonded to a surface of a SiO₂ coating. The boron component of the coating can be homogenously or inhomogenously distributed within the SiO₂ matrix. For example, the silicon coating can include one or more layers of a SiO₂ coating and one or more layers of a boron containing SiO₂ coating. Alternatively, or additionally, the boron component of the coating can be bonded to the surface of the SiO₂ coating surrounding the soft-magnetic powder particles, wherein the SiO₂ coating can also contain a boron component of the coating.

Without being bound by theory, the soft magnetic powder coated with a silicon coating may be considered as having a core-shell structure. Preferably, the soft magnetic powder coated with a silicon coating has a core and shell, wherein the core comprising the soft magnetic powder and shell comprising the silicon coating of formula (I), as described herein.

Preferably, the silicon coating has an average thickness of 2 to 100 nm, more preferably 5 to 70 nm and even more preferably 10 to 50 nm. More preferably, the ratio of silicon coating to the soft-magnetic material is not higher than 0.1 and preferably not higher than 0.02. Thus, a significant decrease in magnetic flux density of the magnetic core obtained by molding the soft-magnetic powder can be prevented.

Preferably, the silicon coating has a halogen content <10.0 ppm, more preferably <5.0 ppm, even more preferably <0.1 ppm.

Preferably, the soft magnetic powder may be selected from reduced or unreduced soft magnetic powders.

Another aspect of the present invention pertains to the process for obtaining the soft magnetic powder coated with a silicon coating as described herein, said process comprising the steps of:
a) mixing the soft-magnetic powder with a silicon precursor and at least one boron compound of formula II

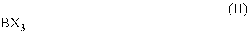

wherein X is selected from H, OH, linear or branched C₁-C₆ alkyl, or linear or branched OC₁-C₆ alkyl, and
b) subjecting the mixture of step a) to heat treatment at a temperature in the range from 350 to 700° C. for a time sufficient to obtain a soft magnetic powder coated with a silicon coating.

The process of the present invention is applicable to both reduced as well as unreduced soft magnetic powders, such as carbonyl iron powder. The reduction step may be carried out prior to step b), simultaneously during step b), or after the coating of the magnetic powder, i.e., after step b). Preferably, the reduction of the soft magnetic powder is carried out in the process step b) by heat treating the mixture in the presence of a reducing agent such as hydrogen gas. Preferably, the heat treatment is performed for a time sufficient to achieve a complete dehydration of the boron compound. As used herein, “complete dehydration” means that the water content in the silicon coating is 1% by weight or below, preferably 0.1% or below, most preferably 0.01% or below. Preferably, the heat treatment of step b) is carried out for a time period from 0.5 to 12 hours, preferably from 1.5 to 10 hours, even more preferably from 3 to 7 hours.

Preferably, the heat treatment of step b) is carried out optionally in the presence of a gas selected from nitrogen, hydrogen or argon, more preferably from nitrogen or hydrogen.

Preferably, the heat treatment of step b) is carried out at a temperature in the range from 370 to 700° C., more preferably from 400 to 700° C., even more preferably from 400 to 680° C., more preferably from 420 to 650° C. Without being bound by theory, it was noted that temperatures >700° C. would lead to unwanted sintering. Furthermore, it was found that dehydration of boron compound was incomplete below 350° C.

The decomposition or hydrolysis of the silicon precursor, preferably the silicon alkoxide, can further be promoted by thermally heating the prepared reaction mixture. The reaction mixture of step a) can be heated to a temperature just below the boiling point or up to reflux of the reaction mixture. In the case of ethanol being employed as inert suspending agent, for example the temperature is kept below 80° C., e.g., around 60° C. Typically, the reaction mixture is dispersed by a mechanical stirrer. Furthermore, dispersing agents such as anionic or ionic surfactants, acrylic resin, pigment disperser or higher alcohols such as hexanol, octanol, nonanol or dodecanol can be added to the reaction mixture.

If the silicon precursor is added stepwise in more than one step, the remaining fractions of silicon precursor, water and catalyst can be added in one or more steps while the reaction mixture is kept at elevated temperature. Preferred is a two-step addition of the metal alkoxide, where the remaining fractions of silicon precursor, water and catalyst are added in one step while the reaction mixture is kept at elevated temperature.

Preferably, the step a) is carried at a temperature T, wherein the T is at least 250° C. lower than the temperature of step b), more preferably T is at least 300° C. lower than the temperature of step b), even more preferably T is at least 400° C. lower than the temperature of step b). More preferably, the temperature of step a) is carried out at a temperature in the range from 20 to 150° C., even more preferably from 40 to 120° C.

Preferably, the step a) is carried out for a time period from 0.5 to 10 hours, preferably from 1 to 8 hours, even more preferably from 1.5 to 5 hours.

Preferably, the silicon precursor is a silicon alkoxide. Such silicon alkoxides provide a soluble form of silicon without any water or hydroxy groups. Thus, a controlled hydrolyzed silicon product is achievable. More preferably, silicon precursor is a compound of formula Si(OR¹)₄, wherein R¹ is selected from linear or branched C₁-C₅ alkyl.

Also suitable are silanes with two or three O—R¹ groups, wherein R¹ is a residue as given above, and two or one X¹ group(s) directly bound to silane, respectively, wherein X¹ is a residue such as H, methyl, ethyl, C₃ to C₁₈ or propylamine, or even more complex examples like (3-glycidyloxypropyl)triethoxysilane as well as mixtures thereof, which may further be mixed with any of the silicon alkoxide mentioned above.

More preferably, the silicon precursor is selected from tetramethylorthosilicate (TMOS), tetraethylorthosilicate (TEOS), tetrapropylorthosilicate, tetraisopropylorthosilicate, or mixtures thereof. Most preferred is tetraethylorthosilicate (TEOS).

Preferably, the boron compound is selected from trihydridoborane, boric acid, boronic acid, trimethylborate, triethylborate, triisopropyl borate, tributylborate, tri-tertbutyl-borate, or mixtures thereof. More preferably, the boron compound is selected from trihydridoborane, boric acid, trimethylborate, triethylborate, or mixtures thereof. Even more preferably, the boron compound is selected from boric acid, triethylborate, or mixtures thereof. Without being bound by theory, it is expected that a boron compound, such as trihydridoborane, would convert to a borate in presence of the solvent, such as alcohol prior to completion of process.

The above-mentioned boron compounds possess superior properties with respect to solubility in ethanol, stability in solution, accessibility and performance of the silicon coatings obtained therewith. Moreover, these boron compounds are characterized by having a lower toxicity and lower environmental impact than alternate additives containing halogens (for instance fluorine-containing compounds such as H₂SiF₆, known from EP 2 871 646 A1).

Preferably, the boron compound has a solubility in ethanol of more than 15 wt.-%, preferably more than 20 weight-% and particularly preferred more than 25 wt.-%, at 0° C. The boron compound can alternatively be specified by a very high solubility in water of more than 25 wt.-%, preferred higher than 30 wt.-% and particularly preferred more than 35 wt.-% at 20° C. Alternatively, or in addition, it is also particularly preferred if the boron compound is a liquid at room temperature and/or may be prepared from constituents which are liquid at room temperature. Preferably, the boron compound are liquid compounds or are prepared in situ from liquid compounds. It is advantageous in terms of processing and handling to select boron compounds that are liquids or solids at STP, for instance boric acid or triethylborate. Also, the boron compound as well as the solution obtained upon its dissolution are compatible with materials sensitive to corrosion (e.g., reactor surfaces).

Preferably, the mixture of step a) has 0.1 to 1.0 mol of boron, more preferably 0.2 to 0.9 mol, even more preferably 0.5 to 0.9 mol, compound per kg of soft-magnetic powder.

Preferably, the mixture of step a) has a mol ratio of boron compound to silicon precursor in the range from 1:5 to 5:1, more preferably from 1:3 to 3:1, even more preferably from 1:2.5 to 2.5:1.

The soft-magnetic powder can be mixed with the inert suspending agent, such as water and/or an organic solvent. Suitable organic solvents are protic solvents, preferably monovalent or divalent alcohols, such as methanol, ethanol, iso-propanol, glycol, diethylene glycol or triethylene glycol, or aprotic solvents, preferably ketones, such as acetone, diketone, ether, e.g. diethyl ether, di-n-butyl ether, dimethyl ether of glycol, diethylene glycol or triethylene glycol, or nitrogenous solvents such as pyridine, piperidine, n-methylpyrrolidine or amino ethanol. Preferably, the organic solvent is miscible with water. The suspending agent can be one or more organic solvent or one or more organic solvent in combination with water. Preferred organic solvents are acetone, isopropanol and ethanol. Particularly preferred is ethanol. Most preferably, the inert suspending agent is selected from ethanol, water, isopropanol, acetone, or combinations thereof. The content of the inert suspending agent is preferably in an amount of up to 70 wt.-% with respect to soft magnetic powder. More preferably, the content of the inert suspending agent lies between 10 and 50 wt.-% with respect to soft-magnetic powder.

In order to coat the soft-magnetic powder with silicon dioxide (SiO₂) the silicon precursor is preferably selected from a silicon alkoxide, which gets readily hydrolyzed in the presence of a suspending agent. Such silicon alkoxides provide a soluble form of silicon without any water or hydroxy groups. Thus, a controlled hydrolyzed silicon product is achievable. Most preferred silicon precursor is tetraethylorthosilicate (TEOS).

After addition of the silicon precursor the hydrolysis occurs automatically in the presence of water. Preferably the total amount of water corresponds to at least twice, more preferably to at least five times the amount of the stoichiometric amount needed for the hydrolysis of the silicon precursor Generally, the total amount of water is not higher than one hundred times, preferably twenty times the stoichiometric amount needed. Preferably, the water content present in industrial grade organic solvent and/or reagents, such as ethanol and/or aqueous ammonia, is sufficient to initiate reaction and no additional water is added separately.

The mixture of the soft-magnetic powder and the suspending agent is chosen such that a miscible solution is obtained. A high solid fraction is favorable in order to increase yield per volume and time. The optimal solid fraction is easily obtainable through routinely carried out experiments, which allow finding the optimal fraction for the reaction mixture. Furthermore, mechanical stirrers or pump/nozzle-devices can be used to increase the solid fraction.

Preferably, the reaction mixture of step a) in inert suspending agent has a pH in the range of 0 to 10, more preferably 6 to 10, even more preferably 8 to 9, measured at 20° C. A pH in the range from 6 to 10, preferably 8 to 9 at 20° C., is preferred in view of the potential corrosion of the equipment used (for instance, the reactor) during the coating process. Moreover, the preferred pH ranges allow mild conditions for the coating of the soft-magnetic powder.

In the present context, without being bound by theory, the process may be subdivided into sequential steps on basis of the chemico-physical changes. For instance, in a first sub-step the components, i.e., soft magnetic powder, silicon precursor and boron compound are hydrolyzed. Preferably, the soft magnetic powder, silicon precursor and boron compound are added simultaneously or sequentially, more preferably, simultaneously in a single addition. For the hydrolysis, further components such as an inert suspending agent, and an optional catalyst may be added. Hydrolysis is followed by drying and distillation to ensure a uniform coating. Preferably, the hydrolysis is carried at a temperature from 20 to 100° C., even more preferably from 40 to 80° C.

After the hydrolysis the reaction mixture is distilled and dried. The point when the hydrolysis finishes can be detected by detecting a decrease in water content in the reflux. If the water content is low enough, the mixture can be distilled and dried leaving the soft-magnetic powder coated with SiO₂. In this context, the level of water content can easily be determined through routine experiments. Preferably, the drying and distillation is carried out at a temperature from 50 to 120° C., even more preferably from 70 to 100° C. The drying and distillation may be carried out as a separate sub-step of step a) or may be combined along with heat treatment of step b). Preferably, the reaction mixture after hydrolysis may be directly subjected to heat treatment of step b). Herein, the drying and distillation may be carried out in a single step along with the heat treatment of step b).

The boron compound may be added either simultaneously or added after at least partial treatment of the soft-magnetic powder with the silicon precursor in step a). Preferably, the boron compound is added simultaneously, along with soft-magnetic powder and silicon precursor in step a). The simultaneous addition of boron compound (in step a) leads to an advantage in terms of process economy over prior art processes such as EP 3821450 A1, which require stepwise addition. Preferably, the boron compound is added in step a) simultaneously during hydrolysis. Hence, the boron compound is added before the reaction mixture is distilled and dried.

The silicon precursor can be added to the reaction mixture as such or dissolved in the inert suspending agent prior to addition. If an inert suspending agent is used, the inert suspending agent contains 10 to 90 wt.-%, preferably 50 to 80 wt.-% of the silicon precursor.

The silicon precursor can be added simultaneously or stepwise. Preferred is a stepwise addition of the silicon precursor in more than one step, preferably two steps. For example, up to 90%, up to 50% or up to 20% of a total amount of silicon precursor is added to the reaction mixture at first and the remaining amount is added at a later stage of the process. More preferably, the entire addition of silicon precursor is completed simultaneously or in a single step, most preferably in a single step. Preferably, the entire addition of silicon precursor is completed in step a) prior to step b).

Preferably, the entire amount of silicon precursor is simultaneously added along with the boron compound. Alternatively, only a part of the silicon precursor is added together with the boron compound. For example, of 100% silicon precursor needed to form 1-2 wt.-% SiO₂ on the iron powder, 25%, 50% or 75% is added together with the boron compound and the rest is added separately, either before or after.

Furthermore, the boron compound can be added portion wise in one or more steps during treatment with the silicon precursor. Preferably the entire amount of boron compound is added together with silicon precursor. The point when the boron compound is added can be chosen somewhere during the first process step a), i.e., mixing the soft-magnetic powder with a silicon precursor and boron compound, and prior to step b).

The sequence of addition of components in the step a) can vary. The silicon precursor can for example be added simultaneously to the reaction mixture of step a) containing the soft-magnetic powder, boron compound and the inert suspending agent or the inert suspending agent and the silicon precursor can be added simultaneously to the soft-magnetic powder followed by the boron compound.

The preferred molar ratio of boron in the boron compound to silicon in the silicon precursor (molar ratio B:Si) is 1:3.5 to 3.5:1, preferably 1:2.8 to 2.8:1, and in particularly 1:1.4 to 2.3:1, wherein the molar ratio refers to the ratio across the whole coating. The molar ratio B:Si may for instance be 1:1. With this ratio the coating can be adapted to provide high permeability due to the thickness of the coating, good temperature and corrosion stability.

The total amount of silicon precursor added depends on the desired thickness of the coating. Depending on the particle size distribution, the profile of the particles (needle like or spherical) and the amount of powder particles added the overall specific surface can easily be determined. Alternatively known methods such as the BET-method can be employed to determine the specific surface area. From the desired thickness of the coating and the density of the silicon precursor, the required amount of silicon precursor can be calculated. The required total amount of silicon precursor can then be determined through the stoichiometry of the reaction.

The reaction mixture in step a) may optionally comprise at least one precursor of titanium, magnesium or aluminum for producing an aluminum oxide (Al₂O₃), magnesium oxide (MgO) or titanium oxide (TiO₂, TiO, Ti₂O₃). Furthermore, the final coating obtained could be based on a mixture of metals, such as Al, Mg or Ti, in addition to boron and silicon.

The decomposition or hydrolysis of the silicon precursor, preferably the silicon alkoxide, can further be promoted by presence of an optional catalyst such as an alkaline or an acidic catalyst, added to the reaction mixture of step a). The amount of catalyst added can also be adjusted in accordance with the silicon precursor added to the reaction mixture. Suitable acidic catalysts are for example diluted mineral acids such as sulphuric acid, hydrochloric acid, nitric acid, and suitable alkaline catalysts are for example ammonia, diluted alkaline lye, such as caustic soda. More preferably, the catalyst is ammonia. Particularly preferred is the use of diluted aqueous ammonia solution so the catalyst and water (for hydrolysis) are added simultaneously in one step.

The soft-magnetic powder coated according to the processes described above and the coated soft-magnetic powder as specified is characterized by having improved economic and environmental impact, in addition to improved permeability combined with unaltered or even improved temperature stability compared to the prior art materials disclosed in EP 2 871 646 A1.

The soft-magnetic powder coated according to the processes described above and the coated soft-magnetic powder as specified above are particularly suitable for the manufacture of electronic components. Electronic components such as magnetic cores may be obtained by subjecting the coated soft-magnetic powder known processes such as press molding or injection molding. To manufacture such electronic components, the coated soft-magnetic powder is typically combined with one or more types of resin, such as epoxy resin, urethane resin, polyurethane resin, phenolic resin, amino resin, silicon resin, polyamide resin, polyimide resin, acrylic resin, polyester resin, polycarbonate resin, norbornene resin, styrene resin, polyether sulfone resin, silicon resin, polysiloxane resin, fluororesin, polybutadiene resin, vinyl ether resin, polyvinyl chloride resin or vinyl ester resin. The method of mixing these components is not limited, and the mixing may be effected in a mixer, for e.g., ribbon blender, tumbler, nauta mixer, henschel mixer or supermixer or kneading machine, banbury mixer, kneader, roll, kneader-ruder, paddle mixer, planetary mixer or monoaxial or biaxial extruder.

To produce a molding, well-known methods may be employed. Initially, the coated soft-magnetic powder can be mixed with one or more types of resin in order to provide a mold powder or ready to press powder. Subsequently, the mold powder can be heated and molten at a melting point of the resin, preferably the thermoplastic resin, and then formed into an electronic component, such as a magnetic core of desired shape. Preferably, the mold powder is finally compressed in a mold to give a magnetic or magnetizable molding. The compression produces a molding which has high strength and good temperature stability.

Compression molding can be carried out by pressing the mold powder or ready to press powder can be pressed in a mold at pressures up to 1000 MPa, preferably up to 500 MPa with or without heating. After compression the molding is left to cure. A process to coat the soft-magnetic powder with resin comprises for example the steps of dissolution of the resin, e.g., epoxy resin, in a suitable solvent, addition of a soft-magnetic powder to the mixture, removal of the solvent from the mixture to give a dry product and grinding of the dry product to give a powder. The ready to press powder is used to produce a magnetic or magnetizable molding.

Powder injection molding allows to production of complex metal parts cost effectively and efficiently. Powder injection molding typically includes molding the soft-magnetic powders together with a polymer as adhesive into the desired shape, the adhesive is then removed and the powder is compacted into a solid metal part in the sintering phase. This works particularly well with carbonyl-iron powder because the spherical iron particles can be packed together very tightly.

The coated soft-magnetic powder as described above may be used in electronic components. Particularly moldings comprising the coated soft-magnetic powder type can be used as coil cores or coil formers as employed in electrical engineering. Coils with corresponding coil cores or coil formers are used by way of example as electromagnets, in generators, in transformers, in inductors, in laptop computers, in netbooks, in mobile telephones, in electric motors, in AC inverters, in electronic components in the automobile industry, in toys, and in magnetic-field concentrators. Electronic components are in particular magnetic core components as used in electrical, electro-mechanical and magnetic devices such as electromagnets, transformers, electric motors, inductors and magnetic assemblies. Further uses of the coated soft-magnetic powder include manufacture of Radio-Frequency Identification (RFID) tags and elements for reflecting or shielding electromagnetic radiation. In the production of RFID tags, which are labels as small as the size of rice grains for automatic object localization or identification, soft-magnetic powder may be employed in printing the RFID structure. Lastly, electronic components manufactured of soft-magnetic powder may be used for shielding electronic devices. In such applications, alternating magnetic field of the radiation causes the powder particles to continuously rearrange themselves. Due to the resulting friction, the powder particles convert the energy of the electromagnetic waves into heat (eddy current loss). Suitably coated magnetic powder particles are therefore highly useful to prevent heat loss.

### EMBODIMENTS

1. A soft magnetic powder coated with a silicon coating, wherein the silicon coating has a formula (I)

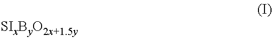

wherein, x=0.5-1.5
y=1.0-1.5, and
the soft magnetic powder coated with a silicon coating is obtained subsequent to a heat treatment at a temperature in the range from 350 to 700° C.
2. The soft magnetic powder coated with a silicon coating of embodiment 1, wherein the silicon coating has an average thickness of 2 to 100 nm, as measured by transmission electron microscopy.
3. The soft magnetic powder coated with a silicon coating of embodiments 1 to 2, wherein the silicon coating has a halogen content <10.0 ppm, preferably <0.1 ppm.
4. The soft magnetic powder coated with a silicon coating of embodiments 1 to 3, wherein boron component of the coating is embedded within a SiO₂-matrix and/or bonded to a surface of a SiO₂-coating.
5. The soft magnetic powder coated with a silicon coating of embodiments 1 to 4, wherein the soft magnetic powder is selected from reduced or unreduced soft magnetic powders.
6. A process for obtaining the soft magnetic powder coated with a silicon coating of any of the preceding claims, said process comprising the steps of:
   a) mixing the soft-magnetic powder with a silicon precursor and at least one boron compound of formula II

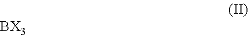

wherein X is selected from H, linear or branched C₁-C₆ alkyl, or linear or branched OC₁-C₆ alkyl, and
b) subjecting the mixture of step a) to heat treatment at a temperature in the range from 350 to 700° C. to obtain a soft magnetic powder coated with a silicon coating.
7. The process of embodiment 6, wherein the heating of step b) is carried out for a time period from 0.5 to 12 hours.
8. The process of embodiments 6 to 7, wherein the silicon precursor is a silicon alkoxide, preferably selected from tetramethylorthosilicate (TMOS), tetraethylorthosilicate (TEOS), tetrapropylorthosilicate, tetraisopropylorthosilicate, or mixtures thereof.
9. The process of embodiments 6 to 8, wherein the boron compound is selected from trihydridoborane, boric acid, boronic acid, trimethylborate, triethylborate, triisopropyl borate, tributylborate, tri-tertbutyl-borate, or mixtures thereof.
10. The process of embodiments 6 to 9, wherein the soft-magnetic powder is mixed with a silicon precursor and the boron compound is added after at least partial treatment of the soft-magnetic powder with the silicon precursor.
11. The process of embodiments 6 to 10, wherein the boron compound has a solubility in ethanol at 0° C. of at least 15 wt.-%, preferably at least 20 wt.-%.
12. The process of embodiments 6 to 11, wherein the mixture of step a) has 0.01 to 1.5 mol of boron compound per kg of soft-magnetic powder.
13. The process of embodiments 6 to 12, wherein the mixture of step a) has a mol ratio of boron compound to silicon precursor in the range from 1:5 to 5:1.
14. The process of embodiments 6 to 13, wherein R is selected from H, linear or branched C₁-C₄ alkyl, or linear or branched OC₁-C₄ alkyl.
15. Use of the soft-magnetic powder of embodiments 1 to 5 or a soft-magnetic powder obtained from the process of embodiments 6 to 14 for the manufacture of electronic components.
16. An electronic component comprising the soft-magnetic powder of embodiments 1 to 5 or a soft-magnetic powder obtained from the process of embodiments 6 to 14.

### EXAMPLES

### Determination of Particle Size

Particle size distribution was determined using Fraunhofer diffraction on a Beckman Coulter LS 13320. The measurement revealed a mono-modal distribution of the particle size with a mean particle size D₅₀ in the range of 1-200 μm. D₅₀ thereby describes the particle size, where 50% of particles are smaller and 50% of particles are larger.

### Coating of Metal Powder—General Procedure A

550 g of a soft-magnetic unreduced powder was reduced for 6 h 570° C. under hydrogen atmosphere. A soft-magnetic reduced powder was obtained. A planetary mixer was loaded with 2.7 kg of a soft-magnetic reduced carbonyl iron powder (CIP) and flushed with argon. Under stirring, 480 mL of ethanol were added and mixed with the powder for 5 minutes. 94 g of tetraethyl ortho silicate (TEOS), 66 g triethylborate and 120 g aqueous ammonia solution were added in the said order. The mixture was heated until an inner temperature of 60° C. was reached and then hold at that temperature. After 3h, temperature was increased to 90° C. to dry the powder.

After drying is completed, the powder was discharged from the planetary mixer and transferred into a chamber oven, where it is heated to 550° C. for 3-6 h under nitrogen atmosphere. Experiments were also successfully conducted with hydrogen atmosphere instead of nitrogen atmosphere.

The boron and silicon content were measured using ICP (B: 0.0139 mol/100 g sample and Si: 0.0146 mol/100 g sample). A number of alternative silicon coatings according to the present invention, wherein the x=0.5 to 1.5; y=1.0 to 1.5, were synthesized and tested for B/Si content. The silicon coating of formula I, wherein x=0.5 to 1.5; y=1.0 to 1.5 were found to show admirable temperature stability. The powder of the present example was further processed into a ring core and analyzed for temperature stability as described below. A value of Uₘₑₜₑᵣ of 0.7 V was found, indicating admirable temperature stability.

### Coating of Metal Powder—Boric Acid Procedure A1

550 g of a soft-magnetic unreduced powder was reduced for 6 h 570° C. under hydrogen atmosphere. A soft-magnetic reduced powder was obtained. A planetary mixer was loaded with 2.7 kg of a soft-magnetic reduced carbonyl iron powder (CIP) and flushed with argon. Under stirring, 480 mL of ethanol were added and mixed with the powder for 5 minutes. 50 g boric acid were dissolved in 120 g aqueous ammonia solution and the solution was added to the suspension, followed by the addition of 112 g of tetraethyl ortho silicate (TEOS). The mixture was heated until an inner temperature of 60° C. was reached and then hold at that temperature. After 3h, temperature was increased to 90° C. to dry the powder.

After drying is completed, the powder was discharged from the planetary mixer and transferred into a chamber oven, where it is heated to 420° C. for 3-6 h under hydrogen atmosphere. Experiments were also successfully conducted with nitrogen atmosphere instead of hydrogen atmosphere.

The boron and silicon content were calculated from the starting material (B: 0.0298 mol/100 g sample and Si: 0.0199 mol/100 g sample). A number of alternative silicon coatings according to the present invention, wherein the x=0.5 to 1.5; y=1.0 to 1.5, were synthesized and tested for B/Si content. The silicon coating of formula I, wherein x=0.5 to 1.5; y=1.0 to 1.5 were found to show admirable temperature stability. The powder of the present example was further processed into a ring core and analyzed for temperature stability as described below. A value of Uₘₑₜₑᵣ of 0 V was found, indicating admirable temperature stability.

### Coating of Metal Powder—Boric Acid Procedure A2

550 g of a soft-magnetic unreduced powder was reduced for 6 h 570° C. under hydrogen atmosphere. A soft-magnetic reduced powder was obtained. A planetary mixer was loaded with 2.7 kg of a soft-magnetic reduced carbonyl iron powder (CIP) and 50 g boric acid (solid) and flushed with argon under stirring for 1h. Subsequently, 480 mL of ethanol were added and mixed with the powder for 5 minutes. 112 g of tetraethyl ortho silicate (TEOS) were added and 107 g of ammonia water were added in said order. The mixture was heated until an inner temperature of 60° C. was reached and then hold at that temperature. After 3h, temperature was increased to 90° C. to dry the powder.

After drying is completed, the powder was discharged from the planetary mixer and transferred into a chamber oven, where it is heated to 420° C. for 3-6 h under hydrogen atmosphere.

The boron and silicon content were calculated from the starting material (B: 0.0298 mol/100 g sample and Si: 0.0199 mol/100 g sample). A number of alternative silicon coatings according to the present invention, wherein the x=0.5 to 1.5; y=1.0 to 1.5, were synthesized and tested for B/Si content. The silicon coating of formula I, wherein x=0.5 to 1.5; y=1.0 to 1.5 were found to show admirable temperature stability. The powder of the present example was further processed into a ring core and analyzed for temperature stability as described below. A value of Uₘₑₜₑᵣ of 0 V was found, indicating admirable temperature stability.

### Coating of Metal Powder—General Procedure B

A planetary mixer was loaded with 2.7 kg of a soft-magnetic unreduced carbonyl iron powder and flushed with argon. Under stirring, 480 mL of ethanol were added and mixed with the powder for 5 minutes. 94 g of tetraethyl ortho silicate, 66 g triethylborate and 120 g aqueous ammonia solution were added in the said order. The mixture was heated until an inner temperature of 60° C. was reached and then hold at that temperature. After 3h, temperature was increased to 90° C. to dry the powder.

After drying is completed, the powder was discharged from the planetary mixer and transferred into a chamber oven, where it is heated to 570° C. for 6 h under hydrogen atmosphere.

The powder of the present example was further processed into a ring core and analyzed for temperature stability as described below. A value of Uₘₑₜₑᵣ of 18 V was found, indicating mediocre temperature stability.

### Coating of Metal Powder—Boric Acid Procedure B1

A planetary mixer was loaded with 2.7 kg of a soft-magnetic unreduced carbonyl iron powder and flushed with argon. Under stirring, 480 mL of ethanol were added and mixed with the powder for 5 minutes. 34 g boric acid were dissolved in 120 g ammonia water and added to the suspension under stirring. Subsequently, 112 g tetraethylorthosilicate (TEOS) were added. The mixture was heated until an inner temperature of 60° C. was reached and then hold at that temperature. After 3h, temperature was increased to 90° C. to dry the powder.

After drying is completed, the powder was discharged from the planetary mixer and transferred into a chamber oven, where it is heated to 570° C. for 6 h under hydrogen atmosphere.

The boron and silicon content were calculated from the starting material (B: 0.0197 mol/100 g sample and Si: 0.0199 mol/100 g sample). A number of alternative silicon coatings according to the present invention, wherein the x=0.5 to 1.5; y=1.0 to 1.5, were synthesized and tested for B/Si content. The silicon coating of formula I, wherein x=0.5 to 1.5; y=1.0 to 1.5 were found to show admirable temperature stability The powder of the present example was further processed into a ring core and analyzed for temperature stability as described below. A value of Uₘₑₜₑᵣ of 0 V was found, indicating admirable temperature stability.

Mixing with Epoxy Resin

100 g of the coated carbonyl iron powder (CIP) were mixed with epoxy resin, e.g. Epikote™ 1004 available from Momentive, by dissolving 2.8 g epoxy resin in 15 to 20 mL of solvent (methylethylketone or acetone) and addition of 0.14 g of dicyandiamide, e.g. Dyhard® 100SH available from Alzchem, as hardener. In a glass beaker the coated CIP is stirred together with the epoxy formulation using a dissolver mixer at 1000 R/min. After mixing the slurry was poured in an aluminum plate, which is then put in a fume hood for 8 h. The resulting dry CIP epoxy plate was milled in a knife mill for 10 seconds to yield the ready to press powder. It comprises 2.8 wt.-% of epoxy resin.

### Molding and Wiring of Ring Core

6.8 g (+0.1 g) of the ready to press powder was put into a steel mold of ring type with an outer diameter of 20.1 mm and an inner diameter of 12.5 mm resulting in a height of approximately 5-6 mm. The ready to press powder is molded at 440 MPa for a couple of seconds. From the exact mass and height of the ring the density of the ring core was calculated. The ring core was wired with 20 windings of an isolated 0.85 mm copper wire, e.g. Isodraht available from Multogan 2000MH 62, for determination of the permeability and resistivity.

### Measurement of Permeability and Resistivity

An LRC meter was used to measure permeability of a ring core. All measurements were done at 100 kHz with 0V DC bias. The test AC current of 10 mA was applied to the ring core.

To measure the resistivity of the pressed parts, a power supply was connected in series to a voltmeter and a sample. 300 Volts were applied to a multimeter and the sample connected in series. Voltage reading of a multimeter was used to estimate the resistance of the sample using following equation.

$${R}_{sample} = {R}_{meter} \times ( {U}_{PS} - {U}_{meter} ) / {U}_{meter} ,$$

where Rₛₐₘₚₗₑ is the resistance of the cylinder, Rₘₑₜₑᵣ is the internal resistance of the meter, Ups is the applied voltage from power supply (=300 V), and Uₘₑₜₑᵣ is the reading from the voltmeter.

### Corrosion Tests

Corrosion stability was tested by exposing the ring cores to aqueous sodium chloride solution (5% w/v). The ring cores were only half immersed in said solution at 85° C. for 5 h. Afterwards, ring cores were taken from the solution, dried and their corrosion compared visually. The ring cores being half immersed in said solution allow easy visual comparison between clean and corroded surface. The test results are summarized in Table 1.

### Temperature Stability

Before the temperature stability test can start the epoxy was cured. This is done by placing the ring cores in oven set to 70° C. After 2 h the ring cores are placed into a second oven set to 155° C. After 2 h the ring cores were taken out for resistivity testing.

Subsequently, the ring cores were placed again into an oven set to 210° C. for a period of time. The measurements were done on samples at intervals of 24 hours, for e.g., after 24 h, after 48 h, and so on. The ring core was labeled as temperature stable if the measured voltage is ≤2.8 V, preferably ≤2 V, more preferably about 0 V, even more preferably 10V after 24 h at 210° C. and ≤30 V, preferably ≤25 V, and in particular ≤20 V, after 48 h at 210° C. Additionally, the measured voltage is preferably ≤70 V, more preferred ≤30 V, and in particular ≤10 V after 120 h at 210° C. The test results are summarized in Table 1.

The samples listed below in Table 1 were prepared on basis of general procedure A (mentioned above) by mixing CIP (soft magnetic powder) with TEOS (silicon precursor). The various samples were obtained by further modifying general procedure A as per the components and parameters as mentioned below in table. For instance, the Blank B2 was prepared according to general procedure A in absence of triethylborate and by restricting heat treatment for 3 hours.

TABLE 1
Test results for establishing temperature
stability and corrosion resistance.

| | Boron | Heat | Uₘₑₜₑᵣ [V] after | |
|---|---|---|---|---|
| Sample | compound | treatment | 24 h 210° C.* | Corrosion |
| B1 | — | — | 295 | — |
| B2 | — | 550° C./3 h | 295 | No |
| CE1 | BF3-benzyl- | — | 285 | Strong |
| | amine | | | |
| CE2 | BF3-benzyl- | 550° C./3 h | 285 | — |
| | amine | | | |
| CE3 | B(OEt)₃ | — | 289 | — |
| IE1 | B(OEt)₃ | 550° C./3 h | 0.7 | No |

—: not tested

### Results

The magnetic particles of general procedure A are treated with silicon precursor, boron compound and also subjected to heat treatment. The ring core was labeled as temperature stable if the measured voltage is ≤2.8 V. The cores obtained from said magnetic powder (IE1) displayed surprisingly low voltage readings (0-2 V) despite a prolonged high temperature treatment (24 h at 210° C.), thus indicating substantially improved thermal stability. Additionally, said cores also displayed high corrosion stability with no visible corrosion despite the treatment with sodium chloride at 85° C. for 5h (as outlined above).

While the corrosion stability was noted to be effective even with blank samples (B2 with no boron compound), the temperature stability of said blank sample was on the other hand poor. With regards to temperature stability tests, the measurement of voltage >2.8 V indicates ineffective insulation by the coating. In case of above-mentioned temperature stability studies, such values indicate a degradation such as crack or defect on the surface of the coating that leads to a loss in its insulative capacity. Here, mere coating of magnetic powders with silica precursor alone (samples B1-B2) was ineffective, thus highlighting the importance of boron compound. It is noteworthy, that alternate boron-containing compound such as BF₃-benzylamine are ineffective both in terms of temperature stability as well as corrosion stability (sample CE1 and CE2). Additionally, the importance of heat treatment may be highlighted from the high voltage values observable for sample CE 3.

1.-15. (canceled)

16. A soft magnetic powder that is coated with a silicon coating, wherein the silicon coating has a formula (I) 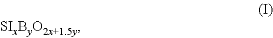
wherein
x=0.5-1.5
y=1.0-1.5, and
the soft magnetic powder coated with a silicon coating is obtained subsequent to a heat treatment at a temperature in the range from 350 to 700° C., and has a mean particle size D₅₀ between 1 and 250 μm.

17. The soft magnetic powder coated with a silicon coating of claim 16, wherein the silicon coating has an average thickness of 2 to 100 nm, as measured by transmission electron microscopy.

18. The soft magnetic powder coated with a silicon coating of claim 16, wherein the silicon coating has a halogen content below 10.0 ppm.

19. The soft magnetic powder coated with a silicon coating of claim 16, wherein boron component of the coating is embedded within a SiO₂-matrix or bonded to a surface of a SiO₂-coating.

20. The soft magnetic powder coated with a silicon coating of claim 16, that has a particle size D₅₀ of from 1 to 50 μm.

21. A process for obtaining the soft magnetic powder coated with a silicon coating of claim 16, said process comprising the steps of:
a) mixing the soft-magnetic powder with a silicon precursor and at least one boron compound of formula II 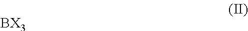
wherein X is selected from H, OH, linear or branched C₁-C₆ alkyl, or linear or branched OC₁-C₆ alkyl, and
b) subjecting the mixture of step a) to heat treatment at a temperature in the range from 350 to 700° C. to obtain a soft magnetic powder coated with a silicon coating.

22. The process of claim 21, wherein the heating of step b) is carried out for a time period from 0.5 to 12 hours.

23. The process of claim 21, wherein the silicon precursor is a silicon alkoxide.

24. The process of claim 23, wherein the silicon alkoxide is selected from tetramethylorthosilicate (TMOS), tetraethylorthosilicate (TEOS), tetrapropylorthosilicate, tetraisopropylorthosilicate, or mixtures thereof.

25. The process of claim 21, wherein the boron compound is selected from trihydridoborane, boric acid, boronic acid, trimethylborate, triethylborate, triisopropyl borate, tributylborate, tri-tertbutyl-borate, or mixtures thereof.

26. The process of claim 21, wherein the soft-magnetic powder is mixed with a silicon precursor and the boron compound is added after at least partial treatment of the soft-magnetic powder with the silicon precursor.

27. The process of claim 21, wherein the boron compound has a solubility in ethanol at 0° C. of at least 15 wt.-%.

28. The process of claim 21, wherein the mixture of step a) has 0.01 to 1.5 mol of organoborate compound per kg of soft-magnetic powder.

29. The process of claim 21, wherein the mixture of step a) has a mol ratio of boron compound to silicon precursor in the range from 1:5 to 5:1.

30. A method for the manufacture of electronic components, the method comprising:
(a) providing a soft-magnetic powder that is coated with a silicon coating, wherein the silicon coating has a formula (I) 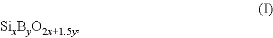
wherein
x=0.5-1.5
y=1.0-1.5, and
the soft magnetic powder coated with a silicon coating is obtained subsequent to a heat treatment at a temperature in the range from 350 to 700° C., and has a mean particle size D₅₀ between 1 and 250 μm, or a soft-magnetic powder obtained from the process of claim 21;
(b) mixing the soft magnetic powder with at least one resin to form a moldable composition;
(c) molding the composition into the desired shape; and
(d) curing or sintering the molded composition to obtain the electronic component.

31. An electronic component comprising a soft-magnetic powder that is coated with a silicon coating, wherein the silicon coating has a formula (I) 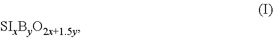
wherein
x=0.5-1.5
y=1.0-1.5, and
the soft magnetic powder coated with a silicon coating is obtained subsequent to a heat treatment at a temperature in the range from 350 to 700° C., and has a mean particle size D₅₀ between 1 and 250 μm,
or a soft-magnetic powder obtained from the process of claim 21.
